(19) United States
(12) Patent Application Publication
(10) Pub. No.: US 2021/0021962 A1
(43) Pub. Date: Jan. 21, 2021

(54) System and method for passive tracking of objects

(71) Applicant: Vicente Diaz Fuente, Alcala de Henares (ES)

(72) Inventor: Vicente Diaz Fuente, Alcala de Henares (ES)

(21) Appl. No.: 16/516,283

(22) Filed: Jul. 19, 2019

(51) Int. Cl. H04W 4/029; H04W 64/00; H04W 4/80; H04W 84/18; H04W 84/12

(52) U.S. Cl. CPC H04W 4/029; H04W 64/003; H04W 84/12; H04W 84/18; H04W 4/80

(57) ABSTRACT

System for the tracking of devices, measurement and tracking of objects and people and of their behaviour related to their movements over time, taking measurement both in real time and in deferred, and including means to measure the strength and/or orientation of the signal received/emitted from nearby devices by means of receiver beacons (r-beacons) (1), means to connect sensors to the beacons (r-beacons) in order to measure external parameters (2), means to interconnect the different adjacent receiver beacons in order to create a mesh network (3), means to send data to the mesh network (4) means for receiving packages of information and sending them to Internet (5), electronic processing means for storing in a database and measurements obtained by the connected sensors (6) and electronic processing means in order to group diverse measurements obtained from the beacons (7).

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT INCORPORATION-BY-REFEENCE OF MATERIAL SUBMITTED ON A COMPACT DISC

Not Applicable

### BACKGROUND OF THE INVENTION TECHNICAL FIELD

### Field of the Invention

This invention is developed in the field of control and tracking of objects and/or people as well as the field of sociodemographic research. As an example but not limited to it, we can speak of its use in the field of control and location of material and human resources in hospitals, buildings, forest protection or protected areas, help for rescue teams, etc. Furthermore, it can be used in the field of analysis and prediction of human indoor and outdoor movements, within buildings such as hospitals, and any geographic scope, intruder detection systems, in applications for the analysis and optimisation of dimensioning infrastructures and spaces, optimisation of urban and interurban transport resources and means, optimisation of out-of-home and indoor advertising, optimisation of electoral campaigns, among others.

Evidently, all the applications in which the location of certain material or human resources is needed, as well as individuals, anonymous or not, classified or not by sociodemographic or psychographic factors can also be benefited by this system and improve their results.

### Description of Related Art

The current measuring and locating systems of measurement and location are based on active beacons located in reference points that issue signals, whether by radio, laser or ultrasound, that allow certain devices to receive these signals and know their position based on the known position of these beacons by means of algorithms based on trilateration techniques, Angle of Departure (AoD), Angle of Arrival (AoA), Flight Time, or similar.

One of the main limitations of these techniques is that the locating devices require “listening to” the signals from the beacons and calculating their position using the information of at least three beacons in order to subsequently send the position to the management system. Therefore, the device being tracked must function as a transmitter and receiver, and requires a data channel for transmitting the position to a management centre or server.

For example, in the case of a label that can be attached to an asset or resource whose control is necessary, it must be able to receive the signals from the beacons, and at the same time, calculate its own position and transmit it to a management centre that allows locating this asset in the system.

Another type of beacon is that used in proximity marketing applications, where they generally want to activate certain actions (messages, downloading an app, discount coupons, etc.) on the nearby users' devices. In these cases these beacons try to connect with the devices actively. Normally, they are used with mobile applications such as Facebook, McDonalds, etc., which offer their customers discounts and other contents in exchange for having the access permissions activated, which allows these companies to know and offer advertising aimed at the users' profiles and, at the same time, “follow them” online by means of their profiles, or Google or Facebook identifiers, and send them this personalised advertising (or retargeting ads) also when they are navigating far from the establishment where they were initially contacted.

Another type of application is that which locates the users in certain areas, allowing their access or, simply, providing information according to their location, in sites such as museums, stores, shopping centres, etc. The fact of having control of each user and of their movements within an environment can serve to plan infrastructures, locate the places with more traffic for external advertising, or, simply, analyse the tastes of the users and optimise their shopping route.

In addition, the analysis of the users' behaviour while buying in a shopping centre can allow obtaining information on their tastes and needs, and even predict the behaviour of users with similar profiles which can be a very interesting sociodemographic analysis tool for certain economic sectors, including companies of exterior and interior (Out of Home (OOH)) advertising and for brands and shopping centres in order to assess and identify the best establishments for each type of business.

The disadvantage of all these applications is that the users of these devices must activate and authorise the connection to the beacons in order to be located and to receive messages, either by downloading specific applications or voluntary activating processes by means of the employees of the shops and/or department stores.

Another type of application is that related to events, concerts and shows in general, in which it is important to detect problems in the flow of persons, especially in closed places where there can be avalanches of persons or blockages that impede the safe performance of the show. The fact of locating the flows of persons facilitates the immediate detection of problems and the rapid response of the security services. The disadvantage of current applications is the need for all or the majority of the attendees to enable the functions that allow these beacons to communicate with the users' devices, thus limiting its real effectivity.

Of all the above, the main limitation of these techniques is that they require the express consent by the persons carrying the device in order to be able to know their position since, in addition, it entails limitations regarding the data protection law by associating non-anonymous users with their positions, and for this reason the term “intrusive” is usually used for this type of techniques.

Reference:

hindawi.com/journals/js/2017/2630413/Recently

Recently patents have appeared related to locating methods in real time using mobile technology as expressed by the North American company Bulzi Media Inc. in its patent US20170041744/A1 “Signal strength determination and mobile device identification tracking system”, and beacons located on advertising supports such as the method described in the patent WO2017176799/A1 “Enhanced mobile device beacon system” of the same company.

All these require the user or device to be in a database so that, upon being detected in the proximities of the external advertising element, it is possible to identify the user carrying it whose sociodemographic characteristics are known. In this way it is possible to expose the users to advertising adapted to their profile, using external points of digital advertising (Digital Out-of-Home (DOOH)).

On the other hand, with the aim of locating users in closed environments, in May 2018 a related article was published in the magazine Sensor (Basel) by You-Wei Lin and Chi-Yi Lin “An Interactive Real-Time Locating System Based on Bluetooth Low-Energy Beacon Network” where it advanced the possibility of connecting a mobile device to the Bluetooth network formed by beacons in mesh mode whose “output” communication is also implemented with a gateway. Nevertheless, the disadvantages of this structure continues being those already explained previously:
Intrusive, because the user must activate the scan mode and their visibility in the mobile device in order to be tracked.
The need of specific software installed in user's mobile device that calculates one's own position and resends it to the network for its management.
The fact that the beacons transmit reference signals makes them easily trackable and they require calibration to guarantee that all the beacons transmit at the same strength, thus, the deployment effort is usually high in terms of costs and time.

From all the above, it is deduced that there is a need for a real-time locating system, that allows identifying devices and/or anonymous users located in the proximities of an area of interest and their movements in a simple, inexpensive, low-detection way and without the need for the users to install any type of software in their devices, or their active registration.

In addition, this system must not be intrusive so that the users does not feel that they are being tracked or have to give their consent, and whose information is sufficient to be able to carry out the tracking without violating their rights and privacy. Lastly, the system must be universal, that is, it must function in any part of the world following the current and future standards.

No backgrounds, patents or utility models, whose characteristics are equal or similar to those envisaged in this invention, are known by the inventor.

### BRIEF SUMMARY OF THE INVENTION

The invention to which this report refers deals with a system and method for measuring and tracking objects and their behaviour related to their movements over time, by using passive beacons, with the aim of being able to make this measurement in both real and deferred time instead of using the current systems of active beacons.

### BRIEF DESCRIPTION OF THE DRAWINGS

In the first place, we list the elements that make up the drawings, taking into account that identical references refer to identical elements.

FIG. 1. It presents the schematic diagram of a typical positioning system where the beacons (1) send to the mobile phones (7) or devices of nearby users reference signals in order to be located in closed or open environments. These devices use an application or app (11) to send the information to a server through its own connection to Internet and must be registered before starting the tracking process.

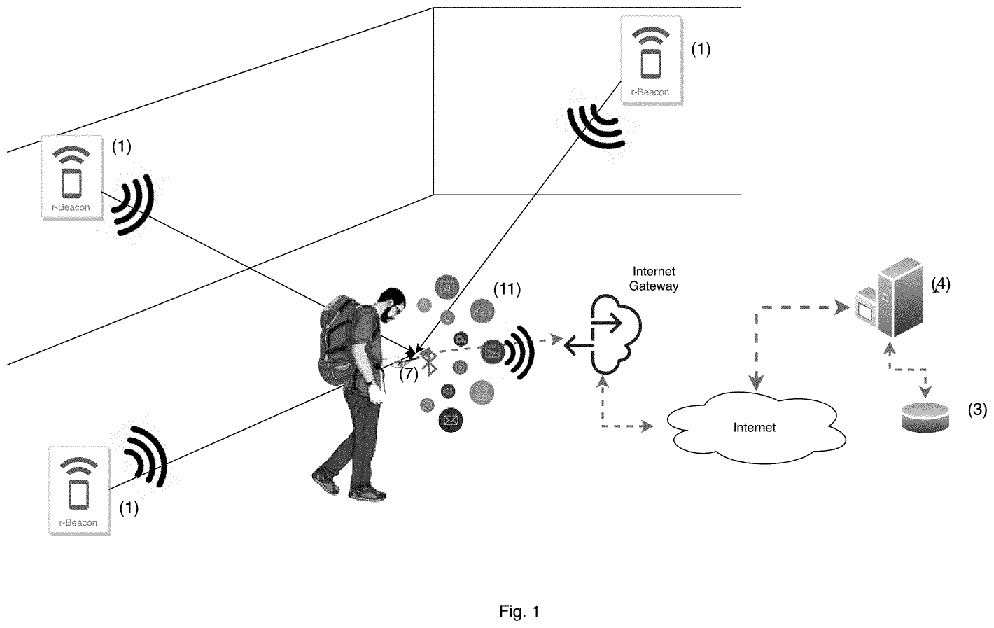

FIG. 2. It presents a schematic diagram of a tracking and positioning system based on this patent, in which the beacons (1) do not emit reference signals but rather they receive the data from the nearby devices without need for registration and communicate between them in order to send the received data until reaching a gateway or router (2) and sending the data to a server (4) and store them in a database (3).

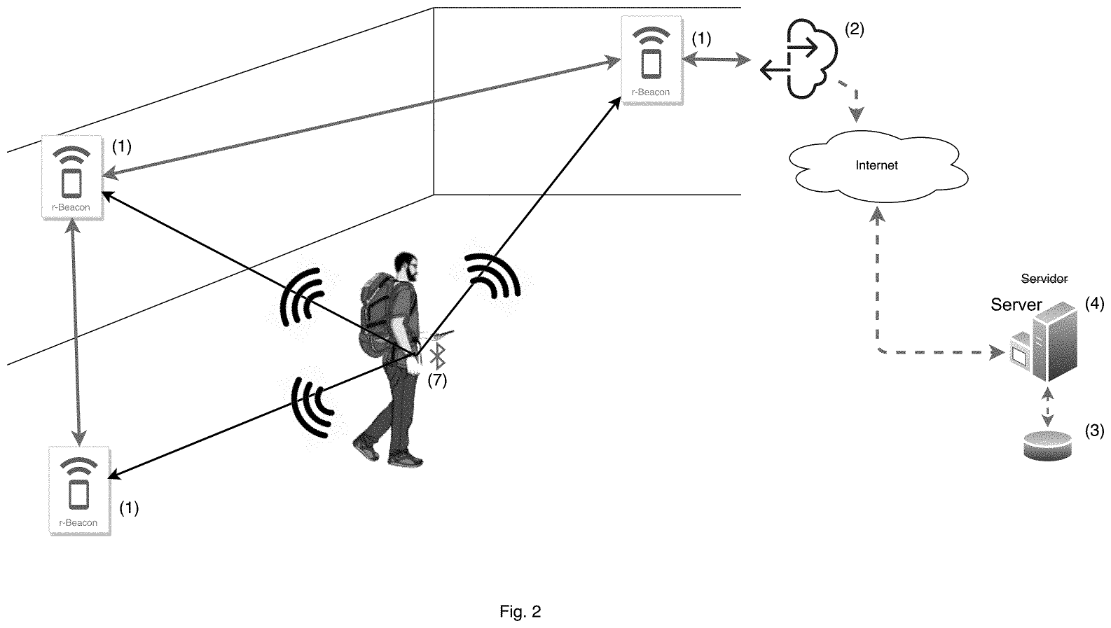

FIG. 3. In the upper part (a) there is a diagram of the communication protocol of the r-beacons and their functioning over time, highlighting the type of signals received and transmitted in each interval. In its lower part (b), a diagram of the communication protocol of the routers or gateways is shown and their functioning over time, highlighting the type of signals received and transmitted in each interval.

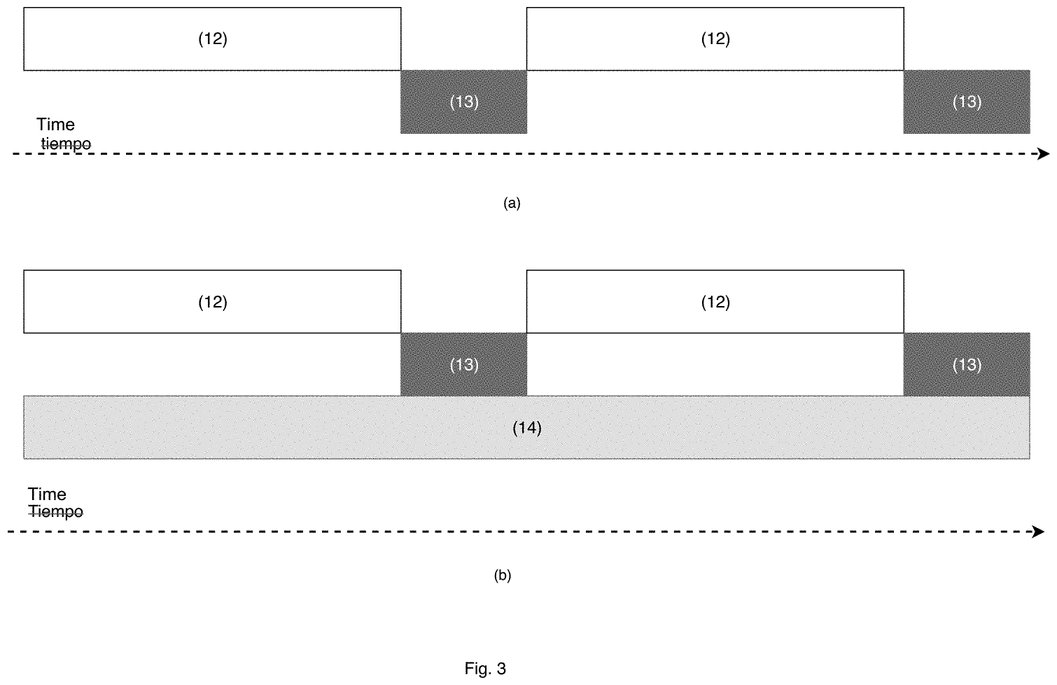

FIG. 4. It shows the diagram of a beacon (r-beacon) based on BLE, its basic components and its interconnection.

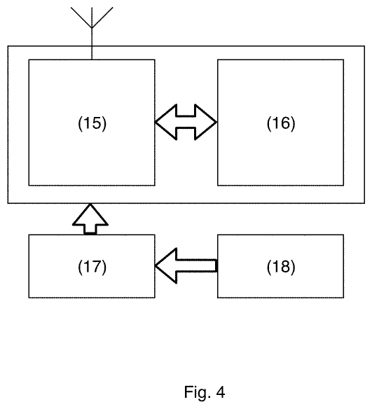

FIG. 5. It shows the diagram of a router or gateway, its basic components and its interconnection.

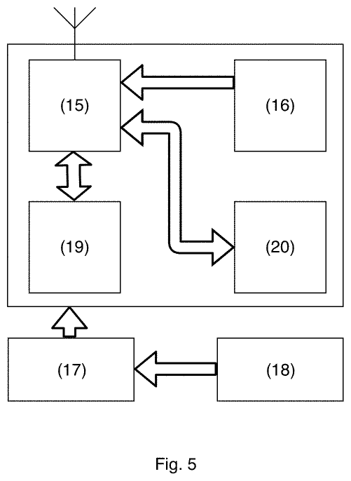

FIG. 6. It shows an example of mesh interconnection, highlighting the fact that each r-beacon (1) has a unique address within it.

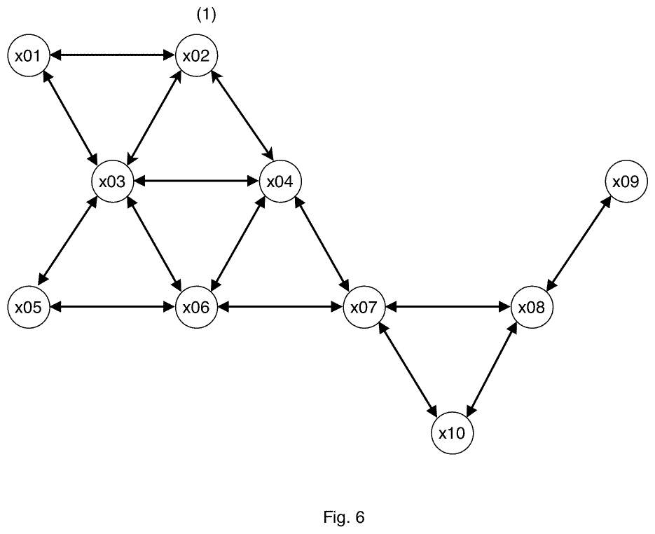

FIG. 7. It shows the diagram of a sensor operation system for the environmental protection, for example, of protected areas in which the main elements described appear: r-beacons (1), gateways or routers (2), remote databases (3), server (4), interconnection between networks by means of gateways (5), mobile devices (6) and tracked devices (7).

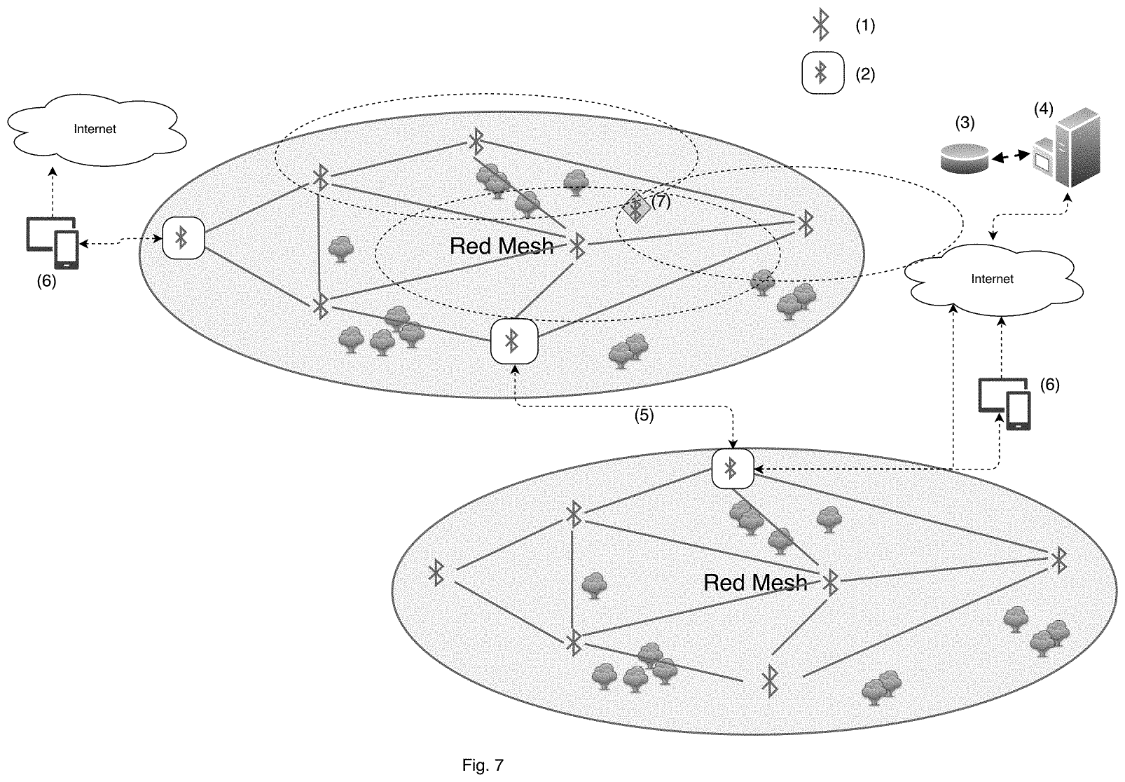

FIG. 8. It shows the diagram of a sensor installation system for the environmental protection, for example, of protected areas in which drones (10) are used to place (launching and embedding thanks to the designs of the screw shaped beacons), to collect the beacons (8) and the automatic establishment of the mesh network with the adjacent beacons (9), as well as the remote inspection in case of warning from the network and interconnection with the server carrying out gateway (2) tasks, and tracking of controlled devices (7) within and outside the area to control.

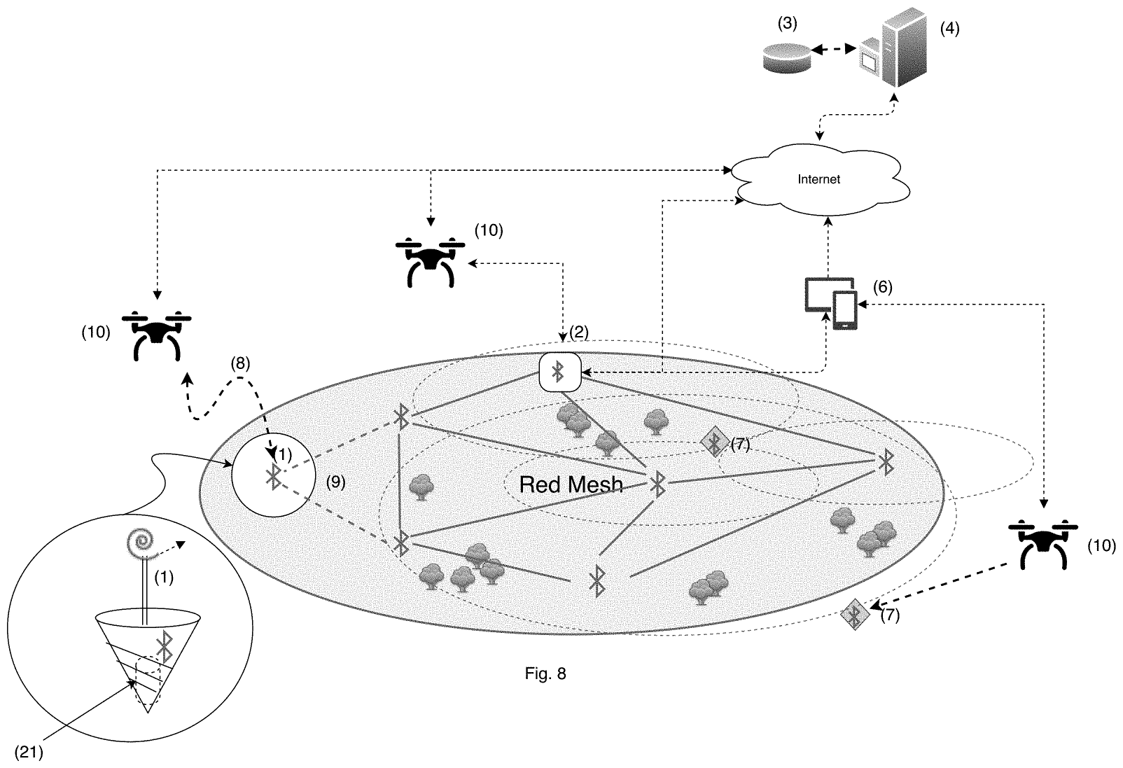

FIG. 9. It shows the diagram of a tracking system for vehicles and/or persons at an access control point that can serve to count the number, allowing the access, detecting unauthorised accesses, measuring the flow of persons or vehicles within an area and their tendencies in order to prevent agglomerations, activate traffic lights, etc.

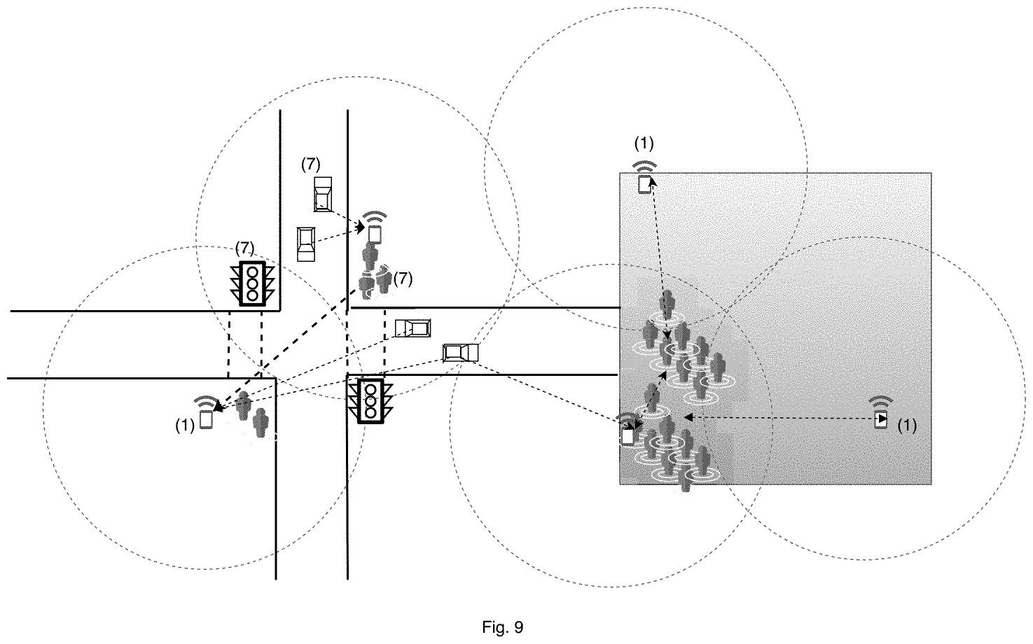

And in all of them, equal elements are defined with the same number, among which are distinguished:
(1) Reading beacons (r-beacons),
(2) gateways and routers that interconnect the mesh network with outside elements through Internet,
(3) remote database,
(4) server for data management and control,
(5) interconnection between mesh networks through gateways,
(6) mobile devices, tablets or local computers for processing data connected to the mesh network,
(7) controlled devices,
(8) placement/launching and collection process of beacons (r-beacons),
(9) process for establishing the interconnection between adjacent beacons,
(10) recognition, maintenance and communication drones,
(11) app installed in a mobile device that allows registering this device to be monitored or located,
(12) Reception period within the communication protocol from an r-beacon,
(13) Transmission period of the data stored in the mesh network towards the nearest gateway or router.
(14) Transmission period of the data received and stored in the memory in the case of a router or gateway device.
(15) BLE (Bluetooth Low Energy) module that performs all the Bluetooth reception and transmission functions.
(16) Array of sensors connected to the BLE module for measuring environmental and/or local parameters.
(17) Power supply management system.
(18) Battery.
(19) Internal memory or buffer where the received data are stored by the router from the mesh network for their subsequent sending to the server or local processing.
(20) Wide-band connection to Internet for the transmitting of the data from the server's memory or to another network in gateway mode among networks.
(21) Load of compressed air for its activation during the autonomous collection of the beacons.

### DETAILED DESCRIPTION OF THE INVENTION

The invention to which this description refers consists of a system and method of locating assets and/or persons within a certain area under analysis, based on low-energy receiver beacons and the calculation of distances, especially in order to carry out its tracking, in order to be used in the applications of asset management and spaces in hospitals, companies, warehouses, buildings, protected areas and forests, for the planning of traditional or digital exterior advertising, as well as knowing the audience that is impacted by certain exterior advertising, and generating exposure data and sociodemographic and psychographic characteristics of the audiences exposed to these advertising elements, and their movements over time.

The purpose of this invention is also to offer a measuring system and a method for calculating the approximate number of individuals or groups of individuals of a certain sociodemographic profile or profiles that move within a defined area that can be used subsequently for calculating the exposure of these individuals to a certain exterior advertising point (OOH) and the associated announcements.

Furthermore, this invention can be used for access tracking and management or traffic analysis or movements of people, vehicles, animals, baggage in airports, train stations or subway, cities, conferences and fairs, shows, public places in general, tracking of minors or patients with mental illnesses or disabilities of any type, in limited areas.

It is also useful for the case of protection and monitoring of protected areas to reduce the risk of provoked fires and poaching, since it can anticipate human activity near the protected area, recording movements and signals, communicating the data to the network. Evidently, the measurements captured by the sensors (temperature and humidity, toxic gases, etc.) that were sent to the network, can also serve to predict the possibility of fires and, during the fire, help the fire-fighting teams to know the movement of the front and its magnitude. Specifically, for this application, the greatest advantage is the use of low-cost and low-weight beacons that allow rapid installation by means of launching it onto the terrain by means of drones and other aerial means, using land vehicles or installing them manually, depending on the terrain. In addition, their maintenance is simple due to their low consumption which allows continuous functioning for years and their collection is ensured due to maintaining the location of each of the beacons in a distributed manner, thanks to the constant interaction with the network elements.

Contrary to the mobile devices, the peripheral devices based on Bluetooth (BLE), such as beacons, smart watches, television sets, routers, music equipment, automobiles, exercise bands, cardiac monitors, earphones, etc., are periodic and constantly transmitting notification signals (named advertising process) with the objective of making themselves known so that the “client” devices (generally mobile phones) can connect to them. During the advertising process, these devices send varied information such as manufacturer, model, single identifier, address, type of device, model and also the received signal power (RSSI).

Based on this fact, the system and method described uses this notified information, for any type of devices, for its use in different applications related to location and asset management.

The fundamental basis of the method for the capture and measurement of activity is the use of low-energy, passive (or receiver) beacons based on the Bluetooth Low Energy (BLE) standard, which we will call r-beacon. These beacons are placed in strategic points that cover the area being monitored or the accesses of the users to that area, so that their main task is to listen constantly to the devices that are around it, reading their parameters and sending them to a management and tracking centre or server for their processing.

Its principal advantage is that it lets them be “invisible” to possible hackers or malicious actions since during the detection process, the beacons do not transmit any type of signal (they are in “mute” mode) and once the “intruding” asset is detected they become activated to transmit this event efficiently, locating and transmitting the information in milliseconds, for which reason the reaction of the intruder would be useless from that instant.

As a consequence of this behaviour, the difference with respect to the current beacon systems is that each beacon must function in listening mode during an interval and in mesh transmission mode in another interval (when it captures new data) in order to be able to transmit the received parameters and these can be processed to obtain their position, which entails the need for a communications channel to the server.

In this regard, the beacons are the basic elements of the system, and they must carry out four main functions:
1. Listen constantly to the “advertising” signals of the nearby devices.
2. Connect to the adjacent beacons, r-beacons, with the objective of creating a “mesh” type private communication network.
3. Transmit the information through the private network to an output point or “gateway” that will connect the network with Internet towards the server or towards another network.
4. Receive the necessary control information, through the private network, coming from the input point or “gateway” that comes in turn from the server.

The BLE standard allows identifying each device in a unique way and it is published within the notified information for which reason the information received is unequivocally associated with a specific device by this identifier.

The technology used to perform the calculation of the distance and, therefore, the position, is not the subject of this patent but, in summary, for locating a device within the network, one can use the received power (RSSI) and any trilateration technique with the unique condition that, at least, three beacons read the parameters of the signal from the same device.

Another of the advantages of this method is that by using receiver beacons, it guarantees that in the same measuring instant, the power transmitted by the device is the same for all the receiver beacons without the need of calibration, which facilitates the calculation of the distance according to the power received, reducing the noise and the information necessary for its calculation, in addition calibration of the beacons is unnecessary, reducing the costs of implementation.

It is also possible to calculate the position using techniques such as angle of arrival (AoA) or angle of departure (AoD) that, using arrays of antennas and certain chips, allow measuring the signal strength and the angle in which it is received. In this way, with a single beacon it is possible to measure the spatial location in 2D and with two beacons the position in 3D in a quite precise manner, depending on the environment.

In addition, for access control applications or those of the flow of persons, such as, for example, entry and exit from the subway or airports by the users in order to understand their usual routes, it is possible to record the passing through an access (entry and exit) so that tracking over time can be done of the transit points of the device (and of the user who carries it) without the need to use an exact position. This application can be implemented with a single beacon since it is only necessary to detect the presence or not of this device and sending it to the server through a gateway.

The system and method described uses the following elements:
a) Beacons, called r-beacons, connected to the adjacent beacons to for a meshed network. These beacons, unlike the current beacons, do not transmit reference signals and their calibration is not necessary, but rather they receive the reference signals from the devices outside the network and send all the information obtained from the devices (including its estimation of position, strength, AoA, AoD, unique IDs, Media Access Control (MAC), and other parameters) through the mesh network to the router or gateway. Optionally, the beacons can be connected to sensors whose measured parameters will also be sent to the network periodically for their use in determined distributed applications.
b) An external peripheral device, which emits periodic advertising signals and that is carried by an asset (person, animal or object) to be tracked within the area.
c) A router or gateway, that can be one of the r-beacons, a mobile phone, a tablet, PC or similar, connected to the mesh network and to Internet, which serves as a bridge between the mesh network and Internet in order to send to the external server the information from the peripheral devices and the information from the sensors connected to the r-beacons.
d) Mobile application software or server, or both, connected to Internet that allows consulting and sending to a database server the information from the devices, associated to the unique ID o MAC (Media Access Controller) Address for each device and for the connected sensors.
e) A database server where the data from the devices and sensors and their history will be stored in order to manage the assets being tracked.

For the correct implementation of the result, the system consists of different elements:
Means to measure the strength and/or orientation of the received/emitted signal of nearby devices by means of at least one beacon (r-beacon).
Means for connecting sensors to the beacons (r-beacons) with the objective of measuring external parameters.
Means for making the interconnection between the different adjacent receiver beacons in a mesh network communication structure.
Means for sending the data of the nearby users' devices, associated with their unique IDs or MACs, and the measurements of the sensors connected to the beacons surrounding the mesh network.
Means for receiving packages of information in one or various devices connected to the mesh network that, in turn, are connected to the Internet (routers or gateways).
Electronic processing means for storing in a database the unique IDs or MACs associated with their historical data of identification, position, RSSI, and measurements obtained by the connected sensors, for their use in the calculation of their location and their management over time within a determined geographical area.
Electronic processing means to group together diverse obtained measurements that will serve to calculate the position and/or geographical coordinates of the users' devices and of the connected beacons.

And the method is the following:

The means for measuring the strength and/or orientation of the received/emitted signal from nearby devices through receiver beacons (r-beacons) allow knowing the relative position of the devices in real time with respect to the beacons whose position is defined during the installation.

The means for connecting sensors to the beacons (r-beacons) to measure external parameters allow measuring certain physical magnitudes or detectors of temperature, humidity, lighting, pressure, position, opening, closing, etc., which allows creating networks of sensors in a distributed manner in a determined area.

The means for implementing the interconnection between the different adjacent receiver beacons in order to create a mesh communication network or any type of similar interconnection structure among all the beacons of the network with the objective of using it to communicate data.

The means for sending data to the mesh network that allow transmitting the information of the users' devices, associated with their unique ID or MAC, and of the sensors connected through it, to any point of the network and to reach, jumping from beacon to beacon, a gateway or router connected to Internet.

The means for receiving packages of information and sending them to Internet, by certain equipment (gateway or router) connected to the mesh network that, in turn, is connected to Internet. This also allows the data sent by the beacons of the network to reach an external server that will be in charge of analysing and managing the historical data and storing them for their later use.

The electronic processing means for storing, in a database, the unique IDs or MACs, associated with their historical identification data, position, RSSI, and measurements obtained by the connected sensors. This information will be used for the calculation of their location and their management over time within a determined geographical area, as well as their graphic representation on a map and other visual media, and making decisions related to the measurements captured by the sensors.

The electronic processing means for grouping different media obtained in the beacons. In this way it is possible to calculate the absolute positions and/or geographical coordinates of the users' devices and that of the connected beacons, obtained using any trilateration algorithm or parallax based on the AoA, AoD or all of them.

The inventor does not know of any previous invention that incorporates the elements that this one presents, or the advantages that it includes.

Description of the preferred embodiment

The invention to which this document refers deals with a system and method to locate any electronic device, affixed to an asset to control, within a certain area (indoor or outdoor) by means of the use of “listening” beacons (r-beacon) that do not emit reference signals like the traditional ones, but rather they listen to the emissions of nearby devices. At the same time, these beacons are connected forming a mesh network so that the information from each beacon is propagated by the network through adjacent beacons until reaching an exit point (gateway) to Internet where the information is sent to a server that processes and stores the information of all the nodes or beacons for their processing, management and analysis. The traditional beacons do not have “intelligence”, they simply offer a reference and do not need to communicate or connect with the devices that surround them.

In order to describe the invention more simply, its application will be explained for the implementation of an environmental protection system, specifically, a fire prevention system, help and support to fire-fighting teams.

In this case, the system consists of 8 main blocks:
Means to measure the strength and/or orientation of the received/emitted signal of nearby devices by receiver r-beacons),
Means for connecting sensors to the beacons (r-beacons) to measure external parameters,
Means for making the interconnection between the different adjacent receiver beacons in order to create a mesh network,
Means for sending the data to the mesh network,
Means for receiving packages of information and sending them to a server in Internet,
Means of electronic processing for storing the unique IDs or MACs in a database,
Means to group together diverse measurements obtained from the beacons,
Electronic processing means to calculate the position of the controlled electronic devices from the grouped data received from the beacons.

In the first place, the means for measuring the strength and/or orientation of the received/emitted signal from nearby devices through receiver beacons (r-beacons) (1) can be based, for example, on the reading of the RSSI value delivered by the surrounding Bluetooth devices in their Advertising messages, and in the measurement of the angle of arrival (AoA) or the angle of departure (AoD) of the received signals. These measurements, captured for all the devices, identified by their unique IDs or MACs, are stored and processed in each of the beacons to be sent to the mesh network.

The means for connecting sensors to the beacons (r-beacons) to measure external parameters (2) allow using environmental information such as humidity, temperature and combustion gases, in order to process them and store them in the beacons in order to be sent to the mesh network.

In order to be able to transmit the data captured by the beacons, the means for implementing the interconnection between the different adjacent receiver beacons are necessary in order to create a mesh network (3). In this process a specific protocol is used in which each beacon is assigned a unique number or address within the network and, automatically, it connects with the adjacent beacons, assigning unique numbers so that, once the mesh is completely created, it is possible to transmit information from one point to another of the network, jumping between the beacons or nodes, that is, that the beacons are in charge of repeating any message that arrives to them from adjacent beacons to others that are nearby until reaching a destination point that can be another receiver beacon or a router/gateway. The only requirement is that each beacon has within its reach at least another beacon or router.

The means for sending data to the mesh network (4) allow the receiver beacons to use certain time intervals for transmitting the data received to the mesh network created with a destination that, generally, is usually a router or gateway.

Means for receiving packages of information and sending them to Internet (5), also called routers or gateways that consist of receiver beacons (r-beacon) that have the dual function of working as a node more than the network but, in addition, serve as a connection point between the network and Internet. They allow collecting all the information from the network and sending it through the Internet to the server.

In the network there can be various elements of this type and it can even be formed by a mobile device or telephone, tablet or computer, a drone or any mobile or fixed equipment that can have Bluetooth and Internet connection and, by means of software, they can emulate the characteristics of a router or gateway, receiving information from the surrounding devices and r-beacons, and sending this information to Internet and/or processing locally the information for the management of the assets of the area.

It is also possible to use routers or gateways to interconnect mesh networks of this type and thus extend their reach or coverage to other areas if it is necessary, for example, in the case of buildings and their connection between floors.

Electronic processing means to store in a database the unique IDs or MACS, associated with their historical data of identification, position, RSSI, and measurements obtained by the connected sensors (6), consisting of hardware and software that can be embedded in any programmable elements by software of the system (r-beacons, routers or servers) that manage and store all the information received from the network in a database for their use in the management of the assets present in the controlled area.

Electronic processing means for grouping diverse measurements obtained from the beacons (7). Using the stored data it is possible to group the information from multiple beacons and, in this way, calculate the absolute position and/or geographical coordinates of the users' devices and from the connected beacons using any trilateration algorithm or parallax based, for example, on the strength received (RSSI), angle of arrival (AoA), or angle of departure (AoD). The information can be presented on a map which will facilitate the management of these assets, their evolution and movement over time, and facilitate decision making.

In the particular case of fire protection, the information can be processed in several ways:
Preventive, using the control of devices outside the network and notifying the intrusion of extraneous elements, their position and movements through the area in order to avoid and/or control provoked fires, notifying the warning systems so that they may examine the area, for example, with autonomous or remotely controlled drones.
The early detection of fires, using humidity, temperature and gas sensors connected to the r-beacons, it is relatively simple to predict the possibility of fire and the system allows locating the position of a focal point of increased activity to evaluate the situation.
Assistance to fire-fighting teams. Once the fire is started, the fire-fighting teams need to locate their teams and assets or vehicles and estimate the fire's evolution (observing the variation over time of the measurements captured by the sensors in localised groups of r-beacons), its magnitude and extension, its speed of movement, orientation, etc., in order to estimate its scope, warn the population and estimate the means, both in the air and on land, necessary to fight it.

In the event that the fire is active and it is not covered previously by this type of devices, the fire-fighting teams can also launch r-beacons in the proximities of the fire by air or land means, which, due to their design, will be affixed in the terrain and will automatically create a mesh network and, using a mobile or portable device configured as a router, be connected to this network to monitor the evolution of the fire in real time, which reduces the human risk and costs of similar systems based on thermal images with aerial vehicles and similar.

The generalisation of this system for locating applications and management of assets in interior sites such as buildings, shopping centres, stations, airports, stadiums, etc., is evident.

Furthermore, it is evident that this system can be used, among others, to measure sociodemographic behaviour of population migrations and movements, of vehicles in cities, detection and tracking of pedestrians through the city's infrastructures (traffic lights, street lights, accesses, car parks, crosswalks, etc.) and by the vehicles themselves in a way that they can detect the approach of other vehicles and pedestrians, reducing accidents or simply detecting their presence in certain areas for making decision of energy optimisation (turning off/on), and security actions and/or access (opening/closing/alarm), and others that could be automated.

Therefore, the invention that is described constitutes a powerful measuring system that facilitates not only the management of assets within a certain area, but also their location and tracking through different locations and the analysis of their behaviour, fundamental for the efficient management of both human and material resources.

Having sufficiently described the nature of the invention, as well as the way of putting it into practice, it must be noted that the provisions indicated above and represented in the attached drawing are susceptible to modifications of detail as long as they do not alter their fundamental principles established in the previous paragraphs and summarised in the following claims.

1. A system for tracking of devices, measurement and tracking of objects and people and of their behaviour related to their movements over time, by means of the use of passive beacons, in real time and in deferred, comprising:
receiver beacons (r-beacons), to measure the strength and/or orientation of the signal received/emitted from nearby devices,
means to connect sensors to the beacons (r-beacons) in order to measure external parameters,
means to interconnect the different adjacent receiver beacons in order to create a mesh network,
means to send data to the mesh network,
means for receiving packages of information and sending them to Internet,
electronic processing means for storing in a database the unique IDs (identifications) or MACs (Media Access Control), associated with their historical data of identification, position, RSSI (Received Signal Strength Indicator), and measurements obtained by the connected sensors,
electronic processing means in order to group diverse measurements obtained from the beacons.

2. The system according to claim 1 wherein the receiver beacons (r-beacons) for measuring the strength and/or orientation of the signal received/emitted by nearby devices are based on the reading of the RSSI value delivered by the surrounding Bluetooth devices in their advertising messages, and in the measurement of the angle of arrival (AoA) or the angle of departure (AoD) of the received signals, these measurements, captured from all the tracked devices, identified by their unique IDs or MACs are stored and processed in each of the beacons in order to be sent to the mesh network.

3. The system according to claim 1 wherein the means for connecting sensors to the beacons (r-beacons) in order to measure external parameters, use environmental information, such as humidity, temperature and combustion gases, in order to process them and store them in the beacons to be sent to the mesh network.

4. The system according to claim 1 wherein the means for interconnecting the different adjacent receiver beacons to create the mesh network, where the data captured by the beacons can be transmitted, is using a specific protocol in which each beacon is assigned a unique number or address within the network and is automatically connected to the adjacent beacons assigning unique numbers and, once the mesh is completely created, it is possible to transmit information from one point to another of the network jumping between the beacons or nodes, so that the beacons are in charge of repeating any message that reaches them from adjacent beacons to others that are found near it until reaching a destination point, which can be another receiver beacon or a router/gateway.

5. The system according to claim 1 wherein the means for sending data to the mesh network allow the receiver beacons to use determined intervals of time to transmit the received data to the mesh network created with a destination that, generally, is usually a router or gateway.

6. The system according to claim 1 wherein the means for receiving packages of information and sending them to Internet, also called routers or gateways, consist of receiver beacons (r-beacons) that have the dual function of working as a node of the network, but they also serve as a connection point between the network and Internet, allowing the collection of all the information of the network and sending it through the Internet to the server.

7. The system according to claim 6 wherein there are various elements of this type in the network and it can even be formed by a mobile device or telephone, tablet or computer, a drone or any mobile or fixed equipment that has Bluetooth and Internet connection and, through software, emulates the characteristics of a router or gateway, receiving information from the surrounding devices and r-beacons, and sending this information to Internet and/or locally processing the information for the management of the assets in the area.

8. The system according to claim 6 wherein the routers or gateways can be used to interconnect mesh networks of this type and thus extend their scope or coverage, if it is necessary, to other areas.

9. The system according to claim 1 wherein the means of electronic processing for storing in a database the unique IDs or MACs, associated with their historical data of identification, position, RSSI, and measurements obtained by the connected sensors, consist of hardware and software embedded in any programmable element by software of the system (r-beacons, routers or servers).

10. The system according to claim 1 wherein the means of electronic processing for grouping diverse measurements obtained from the beacons where the receiver beacons (r-beacons) constantly read the messages that nearby Bluetooth devices emit and send those processed data to adjacent beacons of the mesh network in order to calculate the absolute position and/or geographical coordinates of the users' devices and of the beacons connected using any trilateration algorithm or parallax based on the strength received (RSSI), angle of arrival (AoA), or angle of departure (AoD).

11. The system according to claim 1 wherein the beacons (r-beacons) are installed in the area to be controlled by them being launched over the area of interest, using air or land vehicles, and they are automatically interconnected with the nearby beacons in order to create the mesh network in the area of deployment.

12. The system according to claim 11 wherein the connection of the beacons (r-beacons) to an area is based on its cone shape, by spinning it is affixed to the area and its disconnection and collection is done by means of the use of a load of compressed air that is activated in order to move the beacon upwards and to dislodge it from the terrain.

13. The system according to claim 1 wherein in the beacons (r-beacons) the information from sensors connected to the beacons (r-beacons) and the variation over time of the measurements captured by the sensors in localised groups of r-beacons throughout the mesh network measure the speed, extension and propagation of the data from the sensors, allowing dealing with fires, floods, toxic leaks, and infections in real time.

14. A method for the tracking of devices, measurement and tracking of objects and persons and of their behaviour related to their movements over time, by means of the use of passive beacons, in real time and in deferred comprising the steps of:
stablishing the relative position of the devices in real time with respect to the beacons whose positions are defined during the installation of receiver beacons (r-beacons),
creating networks of sensors in a distributed manner in a determined area by measuring certain physical magnitudes of temperature, humidity, lighting, pressure, position, opening, closing, etc., through measuring external parameters with the means for
connecting sensors to the beacons (r-beacons), creating a mesh communication network or any type of similar interconnection structure among all the beacons of the network with the objective of using it to communicate data through the means for implementing the interconnection between the different adjacent receiver beacons,
transmitting the information of the users' devices, associated with their unique ID or MAC, and of the sensors connected to beacons, to any point of the network and reaching, jumping from beacon to beacon, a gateway or router connected to Internet through the means for sending data to the mesh network,
receiving packages of information and sending them to Internet, by certain equipment (gateway or router) connected to the mesh network that, in turn, is connected to Internet, allowing the data sent by the beacons of the network to reach an external server that will be in charge of analysing and managing the historical data and storing it for their later use,
storing, in a database, the unique IDs or MACs, associated with their historical identification data, position, RSSI, and measurements obtained by the connected sensors through the electronic processing means, this information will be used for the calculation of their location and their management over time within a determined geographical area, as well as their graphic representation on a map and other visual media, and making decisions related to the measurements captured by the sensors,
grouping different media obtained in the beacons through the electronic processing means making it possible to calculate the absolute positions and/or geographical coordinates of the users' devices and that of the connected beacons, obtained using any trilateration algorithm or parallax based on the AoA, AoD or all of them.
